(19) United States
(12) Patent Application Publication
(10) Pub. No.: US 2012/0300263 A1
(43) Pub. Date: Nov. 29, 2012

(54) PRINTING APPARATUS, PRINT CONDITION DETERMINING METHOD AND COMPUTER PROGRAM-RECORDED MEDIUM

(75) Inventor: Tsuneo Kasai, Azumino-shi (JP)

(73) Assignee: SEIKO EPSON CORPORATION, Tokyo (JP)

(21) Appl. No.: 13/480,646

(22) Filed: May 25, 2012

(30) Foreign Application Priority Data
May 26, 2011 (JP) 2011-117675

(51) Int. Cl. G06K 15/00

(52) U.S. Cl. 358/1.18

(57) ABSTRACT

A printing apparatus includes a printing unit which prints a plurality of test regions under a plurality of different print conditions by a printing head, a loading unit which applies a physical load to each of the test regions, a reading unit which reads an image on each of the test regions to which the load has been applied, and a determining unit which determines a print condition suitable for printing among the plurality of different print conditions based on the read image on each of the test regions.

### CROSS REFERENCES TO RELATED APPLICATIONS

The present invention contains subject matter related to Japanese Patent Application No. 2011-117675 filed in the Japanese Patent Office on May 26, 2011, the entire contents of which are incorporated herein by reference.

### BACKGROUND

1. Technical Field

The present invention relates to a technique of determining a print condition that excels in abrasion resistance.

2. Related Art

Various physical loads such as friction are applied to a printed material obtained by printing an image on a print medium when the printed material is handled. At this time, ink is peeled off from the printed material or a surface of the printed material is scratched in some case due to the physical loads depending on print conditions such as an amount and a curing method of ink discharged onto the print medium. Therefore, it is preferable that abrasion resistance representing ink fixing performance, ink adhesiveness, wear resistance, and the like be evaluated so as to determine the print condition.

As for a method of evaluating ink abrasion resistance, the following technique has been disclosed in JP-A-2007-218739, for example. That is, a technique of evaluating abrasion resistance by measuring change over time in contact angles of ink droplets discharged onto a print medium has been disclosed in JP-A-2007-218739. Further, a technique of evaluating abrasion resistance by detecting a frictional force generated between a printed material and a test needle has been disclosed in JP-A-2006-125957. However, these evaluating methods are not suitable for an actual print environment. Therefore, a process of determining a print condition based on an evaluation result and reflecting the print condition to actual printing process becomes complicated and takes much time.

### SUMMARY

An advantage of some aspects of the invention is to provide a technique by which a print condition for obtaining a printed material that excels in abrasion resistance can be determined easily.

The aspects of the invention has been made in order to solve at least a part of the issues mentioned above and can be realized in the following modes or Application Examples.

### APPLICATION EXAMPLE 1

A printing apparatus including a printing head for discharging ink includes a printing unit which prints a plurality of test regions to be printed under a plurality of different print conditions on a print medium by the printing head, a loading unit which applies a physical load to each of the test regions, a reading unit which reads an image on each of the test regions to which the load has been applied, and a determining unit which determines a print condition suitable for printing by the printing head among the plurality of different print conditions based on the read image on each of the test regions.

With this configuration, a plurality of test regions to be printed under a plurality of different print conditions are printed, a physical load is applied to each of the test regions, an image on each of the test regions is read, and a print condition suitable for printing is determined among the plurality of different print conditions based on the read images. Therefore, a print condition for obtaining a printed material that excels in abrasion resistance can be determined easily based on a print result by the printing head which performs printing actually.

### APPLICATION EXAMPLE 2

In the printing apparatus according to the Application Example 1, it is preferable that the printing unit print a plurality of test regions of which amounts of ink to be discharged from the printing head per unit area are made different from one another, and the determining unit determine a print condition relating to an amount of ink to be discharged from the printing head per unit area based on the read image on each of the test regions.

With this configuration, an ink amount per unit area, which makes it possible to obtain a printed material that excels in abrasion resistance, can be determined easily.

### APPLICATION EXAMPLE 3

In the printing apparatus according to the Application Example 1 or the Application Example 2, it is preferable that the printing unit include a first irradiator which applies energy for curing ink discharged onto the print medium, and print a plurality of test regions of which energies to be applied by the first irradiator are made different from one another, and the determining unit determine a print condition relating to energy to be applied by the first irradiator based on the read image on each of the test regions.

With this configuration, an energy irradiation amount which makes it possible to obtain a printed material that excels in abrasion resistance can be determined easily.

### APPLICATION EXAMPLE 4

In the printing apparatus according to the Application Example 3, it is preferable that the printing unit further include a second irradiator which applies energy for curing ink discharged onto the print medium from a direction different from the first irradiator, and print a plurality of test regions of which amounts or presence/absence of energy to be applied by the second irradiator are made different from one another, and the determining unit determine a print condition relating to energy to be applied by the second irradiator based on the read image on each of the test regions.

With this configuration, an energy irradiation amount and a direction suitable for energy irradiation, which make it possible to obtain a printed material that excels in abrasion resistance, can be determined easily.

The aspects of the invention can be also configured as a print condition determining method, a printing method, and a computer program, in addition to the configuration as the printing apparatus described above. The computer program may be recorded in a computer-readable recording medium. As the recording medium, various media such as a flexible disk, a CD-ROM, a DVD-ROM, a magnetooptical disc, a memory card, a hard disk, and so on can be used.

### BRIEF DESCRIPTION OF THE DRAWINGS

The invention will be described with reference to the accompanying drawings, wherein like numbers reference like elements.

FIG. 1 is a descriptive view illustrating a schematic configuration of a printing apparatus according to an embodiment of the invention.

FIG. 2 is a flowchart illustrating print condition determination processing.

FIG. 3 is a descriptive view illustrating an example of a test pattern on which test regions are printed.

FIG. 4 is a descriptive view illustrating a specific example in which a print condition is determined based on a differential value ΔE.

FIG. 5 is a view for explaining a method of determining a print condition when an energy irradiation direction is included in a print condition.

FIG. 6 is a view for explaining a method of determining a print condition in consideration of a minimum amount of ink which can be used per unit area.

FIG. 7 is a view for explaining a method of determining a print condition based on an ink duty limit level only.

FIG. 8 is a view for explaining a method of determining a print condition based on an energy irradiation amount only.

FIG. 9 is a view for explaining a method of determining a print condition without taking a rear surface energy irradiation amount into consideration.

### DESCRIPTION OF EXEMPLARY EMBODIMENTS

### A. Configuration of Printing Apparatus

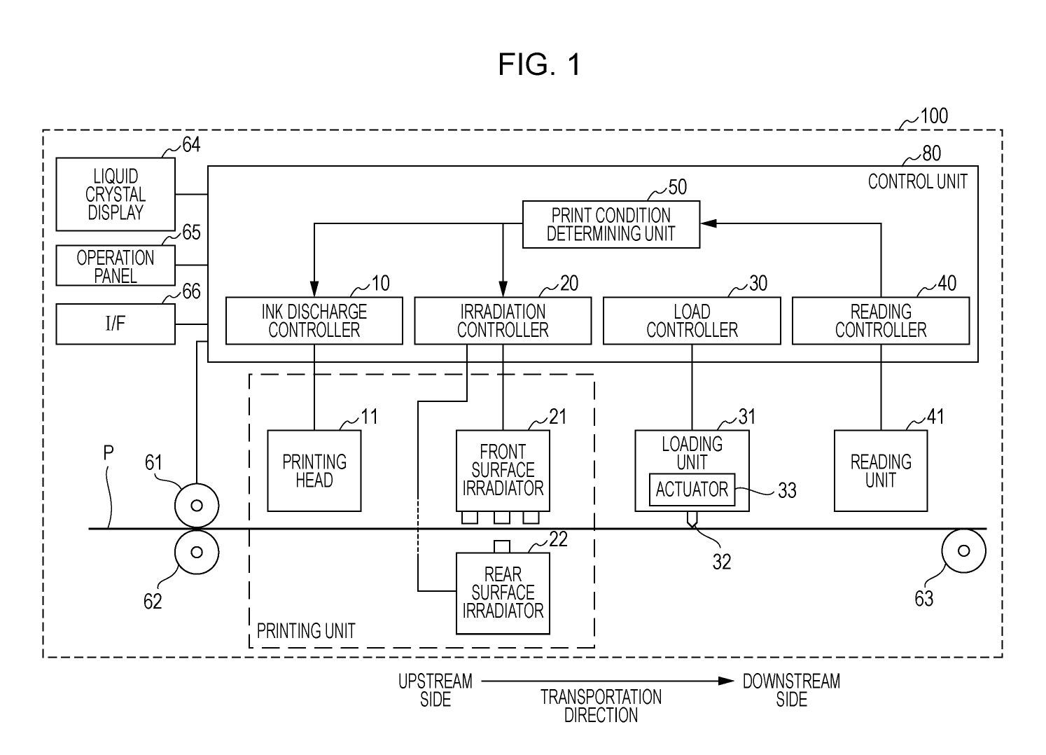

FIG. 1 is a descriptive view illustrating a schematic configuration of a printing apparatus according to an embodiment of the invention. A printing apparatus 100 is configured as an ink jet line printer. The printing apparatus 100 includes a control unit 80, a printing head 11, a front surface irradiator 21, a rear surface irradiator 22, a loading unit 31, a reading unit 41, transportation rollers 61 to 63, a liquid crystal display 64, an operation panel 65, and an interface 66. The printing head 11, the front surface irradiator 21, and the rear surface irradiator 22 correspond to a printing unit according to the invention.

The transportation rollers 61 to 63 transport a print medium P from a side at which the printing head 11 is installed to a side at which the reading unit 41 is installed (hereinafter, referred to as transportation direction). In the embodiment, the print medium P is a white print paper.

The printing head 11 functioning as the printing unit includes ink cartridges (not illustrated). In the embodiment, the ink cartridges include ultraviolet curable inks of black (K), cyan (C), magenta (M), yellow (Y), white (W), and clear (CL). Nozzle rows corresponding to the above colors of inks are formed on the printing head 11. If these ink cartridges are attached to the printing head 11, inks can be supplied from the ink cartridges to the printing head 11.

As illustrated in FIG. 1, the front surface irradiator 21 is arranged at a surface side of the print medium P. The rear surface irradiator 22 is arranged at a rear surface side of the print medium P. The front surface irradiator 21 and the rear surface irradiator 22 irradiate the print medium P with ultraviolet energy as energy for curing ink discharged onto the print medium P. To be more specific, the front surface irradiator 21 applies ultraviolet energy from the surface side and the rear surface irradiator 22 applies ultraviolet energy from the rear surface side. The front surface irradiator 21 corresponds to a first irradiator according to the invention and the rear surface irradiator 22 corresponds to a second irradiator according to the invention.

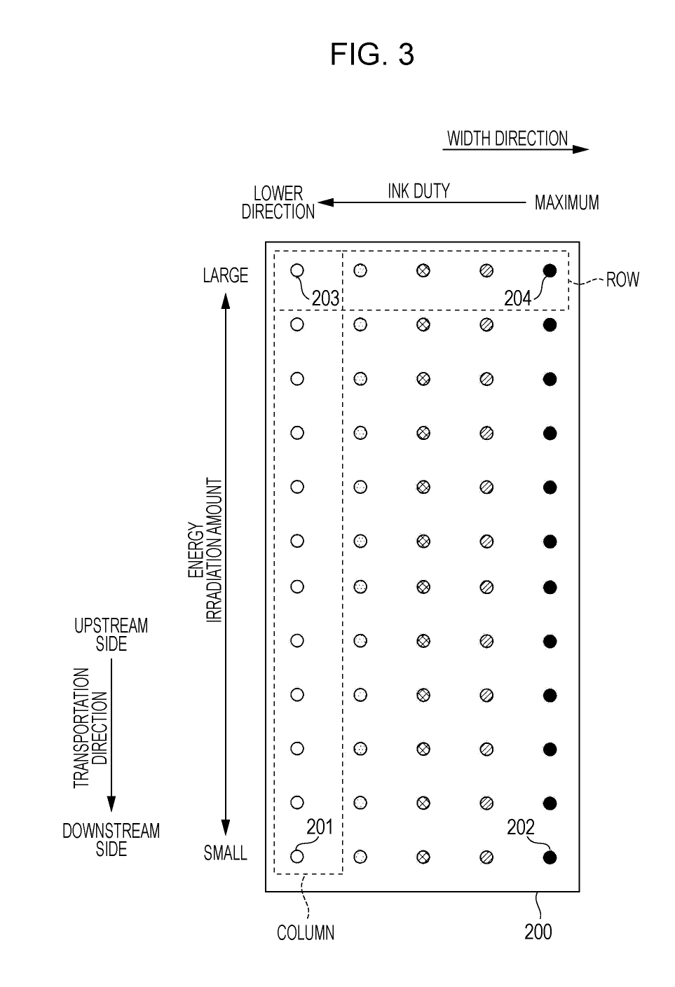

The loading unit 31 includes an electrically-driven actuator 33, and a plurality of test needles 32 which are arranged substantially orthogonally to the transportation direction of the print medium P. At the time of print condition determining processing, which will be described later, the loading unit 31 operates the actuator 33 to move up and down the test needles 32 with respect to each test region on a test pattern (see, FIG. 3) to be printed on the print medium P so as to apply a load to each test region. The loading unit 31 accommodates the test needles 32 in the loading unit 31 when a load is not required to be applied to each test region at the time of the print condition determining processing or when an image is printed (normal printing is performed). The test pattern and each test region will be described later.

The reading unit 41 includes a reading sensor and a light source (they are not illustrated). The light source emits irradiation light onto a reading position of the reading sensor. The reading sensor is a color image capturing element (image sensor) which receives light reflected at the reading position and can receive lights of colors of RGB.

The control unit 80 is configured by a CPU, a RAM, and a ROM (they are not illustrated). The CPU extracts control programs stored in the ROM onto the RAM and executes the control programs so as to operate as an ink discharge controller 10, an irradiation controller 20, a load controller 30, a reading controller 40, and a print condition determining unit 50. Further, the operation panel 65, the liquid crystal display 64, and the interface 66 are connected to the control unit 80. The operation panel 65 performs various operations relating to printing. Various pieces of information relating to printing are displayed on the liquid crystal display 64. The interface 66 is a member for acquiring image data from a computer (not illustrated).

The ink discharge controller 10 adjusts an amount of ink to be discharged onto the print medium P by controlling the printing head 11. To be more specific, the ink discharge controller 10 controls vibration of piezoelectric elements by adjusting a voltage to be applied to the piezoelectric elements provided on the nozzles formed in the printing head 11 so as to discharge ink droplets. With this configuration, the ink discharge controller 10 prints an image corresponding to image data input as a print target on the print medium P in the normal printing. Further, the ink discharge controller 10 prints a test pattern including test regions on the print medium P at the time of the print condition determining processing, which will be described later.

The irradiation controller 20 controls an amount of ultraviolet energy to be applied from the front surface irradiator 21 and controls an amount and presence/absence of ultraviolet energy to be applied from the rear surface irradiator 22.

The load controller 30 controls the actuator 33 included in the loading unit 31 so as to operate the test needles 32.

The reading controller 40 controls the reading unit 41 to execute reading of the test pattern printed on the print medium P so as to generate read image data.

The print condition determining unit 50 determines a print condition based on a reading result of each test region on the test pattern to which a load has been applied by the test needles 32. In the embodiment, the print condition indicates an ink duty limit level, an energy irradiation amount, and the like. Hereinafter, the print condition determining processing will be described.

### B. Print Condition Determining Processing

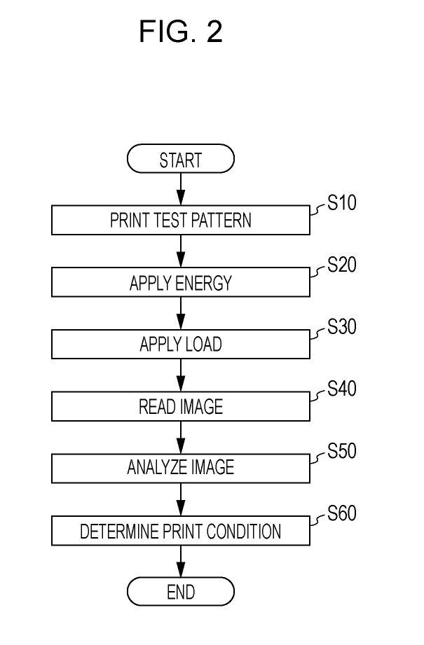

FIG. 2 is a flowchart illustrating the print condition determining processing. The processing is a processing of automatically determining a condition of printing by the printing head 11, the front surface irradiator 21, and the rear surface irradiator 22. If the printing apparatus 100 receives a start instruction for determining the print condition through the computer connected to the operation panel 65 and the interface 66, the printing apparatus 100 executes printing of a test pattern on a test medium set as the print medium P (step S10).

FIG. 3 is a descriptive view illustrating an example of the test pattern on which test regions have been printed. A test pattern 200 as illustrated in FIG. 3 has 60 test regions in total. To be more specific, the test pattern 200 has 12 test regions in the transportation direction (lengthwise direction of the test pattern 200 as illustrated in FIG. 3) and 5 test regions in the width direction (direction which is substantially orthogonal to the lengthwise direction of the test pattern 200 as illustrated in FIG. 3). The test region refers to each region indicated by a circle in the test pattern 200 as illustrated in FIG. 3. In the embodiment, each test region is printed with black ink.

Ink amounts (ink duties) of five test regions lined in one row in the width direction per unit area are different from one another. The ink amount of the test region per unit area is the smallest on a test region 203 at a left end in FIG. 3 and the largest on a test region 204 at a right end in FIG. 3 on a row (row in the width direction) on which the test region 203 and the test region 204 have been printed. Further, on the test pattern 200 as illustrated in FIG. 3, ink amounts of 12 test regions per unit area are equal to one another on a column (column in the transportation direction). For example, an ink amount of the test region 203 at an upper left end in FIG. 3 per unit area is equal to an ink amount of a test region 201 at a lower left end in FIG. 3 per unit area. In the same manner, an ink amount of a test region 204 at an upper right end in FIG. 3 per unit area is equal to an ink amount of the test region 202 at a lower right end in FIG. 3 per unit area.

If the test pattern 200 having the test regions has been printed as described above, the irradiation controller 20 controls the front surface irradiator 21 and the rear surface irradiator 22 to irradiate the test pattern 200 with ultraviolet energy (step S20). The ultraviolet energy is applied in order to cure ink on each test region on the test pattern 200. The front surface irradiator 21 gradually increases an ultraviolet energy irradiation amount (hereinafter, also referred to as “energy irradiation amount” simply) from a downstream side toward an upstream side in the transportation direction for each row of the test regions on the test pattern 200 as illustrated in FIG. 3. Accordingly, an energy irradiation amount of the test region 203 at the upper end in FIG. 3 is larger than that of the test region 201 at the lower end in FIG. 3. In addition, energy irradiation amounts of the test regions in each row are equal to one another. For example, an energy irradiation amount of the test region 201 at the left end in FIG. 3 is equal to an energy irradiation amount of the test region 202 at the right end in FIG. 3 and an energy irradiation amount of the test region 203 at the left end in FIG. 3 is equal to an energy irradiation amount of the test region 204 at the right end in FIG. 3.

If each test region on the print medium P onto which energy is applied reaches the loading unit 31, the load controller 30 controls the actuator 33 to move up and down the test needles 32 so as to apply a physical load to each test region (step S30). A magnitude of the load can be set as follows. That is, a relationship between the degree of scars to be generated on the printed material and the magnitude of the load is previously obtained through an experiment and the magnitude of the load can be set based on the relationship in accordance with quality of a desired printed material and an environment in which the printed material is used.

If each test region on the print medium P to which a load has been applied reaches the reading unit 41, the reading controller 40 controls the reading unit 41 to read an image on each test region on the test pattern printed on the print medium P so as to generate read image data (step S40). To be more specific, the light source included in the reading unit 41 irradiates each test region with light and the reading sensor receives reflected light of the source light. The reading unit 41 generates read image data in an RGB format based on the reflected light.

If the reading controller 40 generates the read image data, the print condition determining unit 50 analyzes the read image data (step S50). To be more specific, the print condition determining unit 50 calculates a difference of a brightness value (hereinafter, referred to as differential value ΔE) between a portion of each test region to which a load has been applied and a portion of each test region to which a load has not been applied based on an RGB value of the read image data. The magnitude of the differential value ΔE increases as the scar on the portion of each test region to which the load has been applied becomes larger. Therefore, the differential value ΔE can be set as an index for evaluating the abrasion resistance.

Next, the print condition determining unit 50 determines a print condition based on the differential value ΔE (step S60). To be more specific, first, the print condition determining unit 50 selects a print condition where the differential value ΔE is equal to or lower than a predetermined threshold value. A relationship between the degree of scars to be generated on the printed material and the differential value ΔE is obtained through an experiment so that the threshold value can be previously defined based on a result of the experiment. When there is one condition where the differential value ΔE is equal to or lower than the predetermined threshold value, the print condition determining unit 50 determines the one print condition as a print condition of the printing apparatus 100. On the other hand, when there are a plurality of print conditions where the differential value ΔE is equal to or lower than the predetermined threshold value, the print condition determining unit 50 selects a print condition where an ink amount per unit area is the largest (ink duty limit is the largest) among the plurality of print conditions. When there are further a plurality of print conditions where the ink duty limit is the largest, the print condition determining unit 50 selects a print condition where an energy irradiation amount is the smallest among the plurality of print conditions.

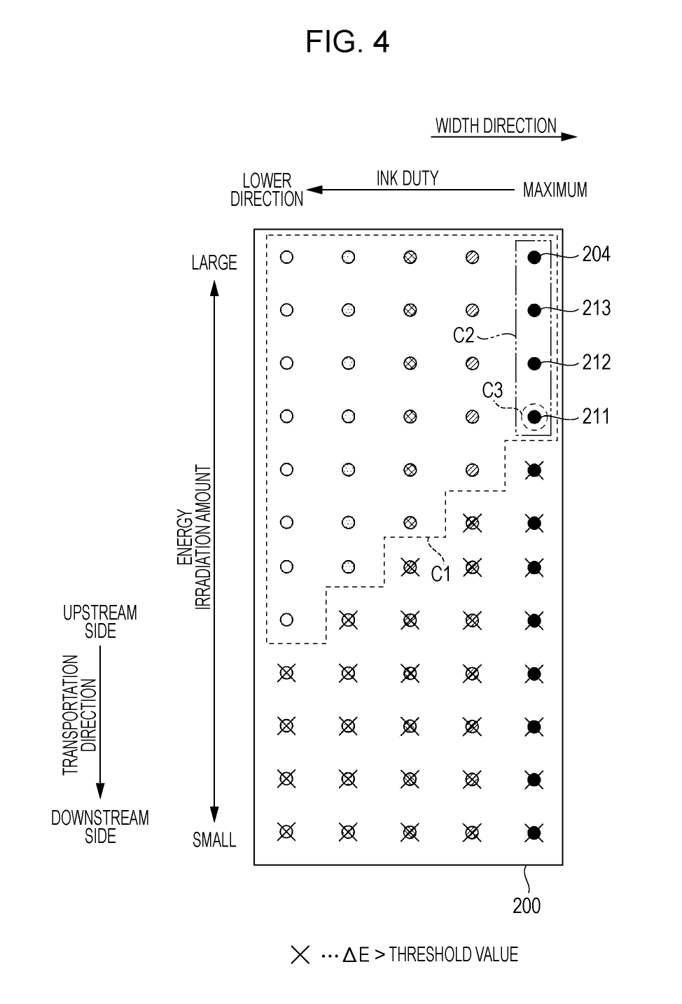

FIG. 4 is a descriptive view illustrating a specific example in which the print condition is determined based on the differential value ΔE. Test regions to which a symbol “x” is marked are test regions each having a differential value ΔE of larger than the predetermined threshold value. That is to say, any of print conditions on test regions to which the symbol “x” is not marked are print conditions under which a printed material that excels in abrasion resistance can be obtained.

On the test pattern 200 as illustrated in FIG. 4, there are a plurality of print conditions C1 (print conditions surrounded by a dashed line C1) where the differential value ΔE is equal to or lower than the predetermined threshold value. In such a case, the print condition determining unit 50 selects print conditions C2 (print conditions corresponding to test regions 211, 212, 213, 204) where the ink duty limit is the largest among the print conditions C1 in accordance with the above processing at step S60. These print conditions are print conditions under which a printed material that excels in abrasion resistance can be obtained even if printing is performed by using a large amount of ink.

In the example as illustrated in FIG. 4, there are a plurality of the print conditions C2 (print conditions corresponding to test regions 211, 212, 213, 204) where the ink duty limit is the largest. Therefore, the print condition determining unit 50 selects a print condition C3 where the energy irradiation amount is the smallest among the print conditions C2. A print condition where the energy irradiation amount is the smallest among the print conditions corresponding to the test regions 211, 212, 213, 204 is the print condition C3 corresponding to the test region 211. This print condition is a print condition under which not only a printed material that excels in abrasion resistance can be obtained but also printing reduced in cost and time required for the energy irradiation can be performed even when printing is performed by using a large amount of ink.

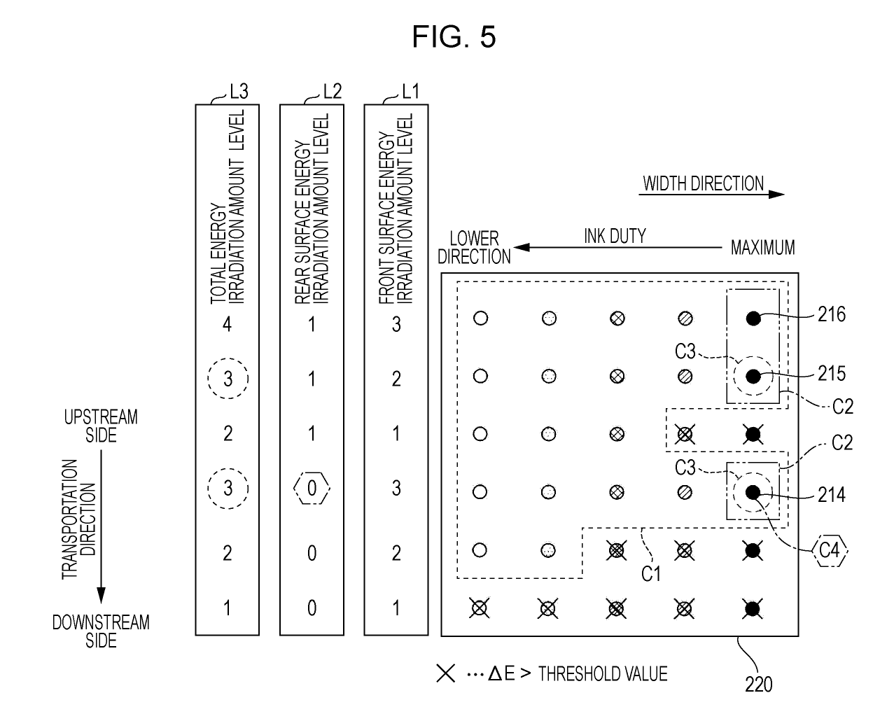

The example in which the ink duty limit level and the energy irradiation amount are included in the print condition has been described in FIG. 4. However, the print condition determining unit 50 can make an energy irradiation direction be included in the print condition. FIG. 5 is a view for explaining a method of determining a print condition when the energy irradiation direction is included in the print condition. In the embodiment, the energy irradiation directions are two directions including the direction toward the front surface of the print medium P and the direction toward the rear surface thereof. Such energy irradiation in the directions can be performed by using the front surface irradiator 21 and the rear surface irradiator 22 as illustrated in FIG. 1. In FIG. 5, “surface energy irradiation amount level L1” indicates an irradiation amount of energy applied from the front surface irradiator 21 and “rear surface energy irradiation amount level L2” indicates an irradiation amount of energy applied from the rear surface irradiator 22. Further, “total energy irradiation amount level L3” indicates a total energy irradiation amount. When a value of the rear surface energy irradiation amount level L2 is 0, the rear surface irradiator 22 applies no energy.

When the energy irradiation direction is included in the print condition, the print condition determining unit 50 also selects a print condition in the same manner as the above print condition determining processing. On a test pattern 220 as illustrated in FIG. 5, there are a plurality of print conditions C1 (print conditions surrounded by a dashed line C1) where the differential value ΔE is equal to or lower than the predetermined threshold value. Therefore, first, the print condition determining unit 50 selects print conditions C2 (print conditions corresponding to test regions 214, 215, 216) where the ink duty limit is the largest among the print conditions C1. Next, the print condition determining unit 50 selects print conditions C3 (print conditions corresponding to test region 214, 215) where the total energy irradiation amount level L3 is the smallest among the print conditions C2. Further, since there are a plurality of print conditions C3, the print condition determining unit 50 selects a print condition based on presence/absence of the rear surface energy irradiation. The test region 214 and the test region 215 have equal total energy irradiation amount levels L3. However, the test region 214 has the rear surface energy irradiation amount level L2 of 0 while the test region 215 has the rear surface energy irradiation amount level L2 of 1. Accordingly, the print condition determining unit 50 selects a print condition C4 corresponding to the test region 214.

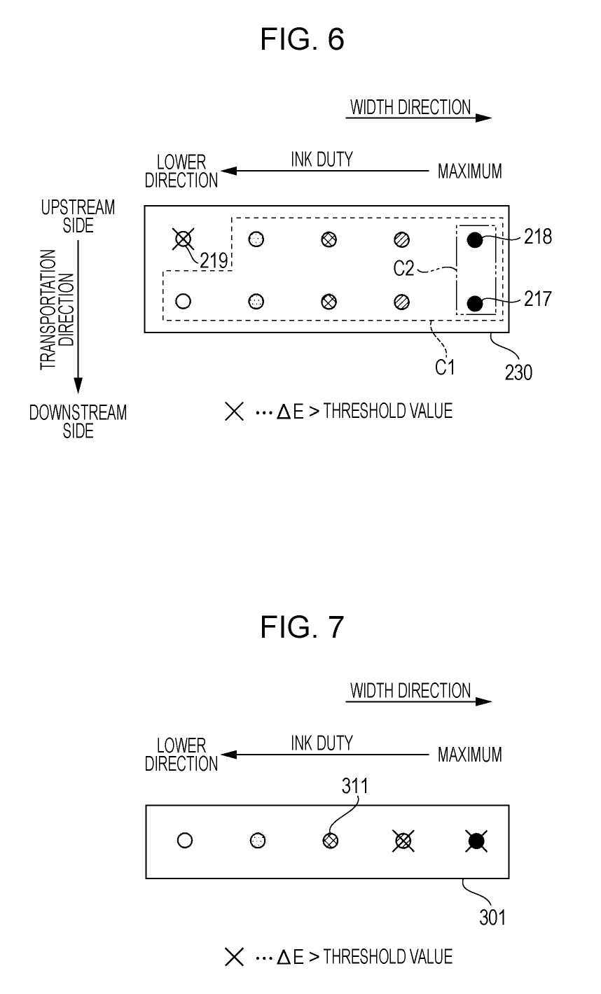

The print condition determining unit 50 can also determine a print condition in consideration of a minimum amount of ink which can be used per unit area (lower limit value of ink duty limit) in the above print condition determining processing. FIG. 6 is a view for explaining a method of determining a print condition in consideration of the minimum amount of ink which can be used per unit area. On a test pattern 230 as illustrated in FIG. 6, there are a plurality of print conditions C1 (print conditions surrounded by a dashed line C1) where the differential value ΔE is equal to or lower than the predetermined threshold value. Therefore, the print condition determining unit 50 selects print conditions C2 (print conditions corresponding to test regions 217, 218) where the ink duty limit is the largest among the print conditions C1 in the same manner as the above print condition determining processing. These print conditions are print conditions under which a printed material that excels in abrasion resistance can be obtained even if printing is performed by using a large amount of ink. However, if the print condition corresponding to the test region 218 is selected, the differential value ΔE exceeds the predetermined threshold value and the abrasion resistance is deteriorated when the ink amount is decreased to an amount corresponding to an ink amount of a test region 219 located in the same rows (width direction) as the test region 218. Such a phenomenon in which the abrasion resistance is deteriorated if the ink amount is decreased occurs because of curing failure of ink due to oxygen in some case, for example. Accordingly, the print condition determining unit 50 selects a print condition of the test region 217 with which a range of the ink duty limit becomes broader when the lower limit value of the ink duty limit is added to the print condition.

If the print condition has been determined as described above, the printing apparatus 100 performs printing on the print medium P while automatically reflecting the determined print condition. If the printing apparatus 100 acquires image data from a computer through the interface 66 and image data for printing and information relating to printing, such as the number of printing and a print size, are input thereto through the operation panel 65, the printing apparatus 100 starts printing processing based on the input image data by using the print condition determined by the print condition determining unit 50.

With the print condition determining processing according to the embodiment as described above, a load is applied to each test region on a test pattern printed under a plurality of print conditions such as the ink duty limit level and the energy irradiation amount with the test needles 32. With this, a state where various physical loads such as friction are generated on a print surface of the printed material can be simulated. Then, a differential value ΔE of brightness between a test region to which a load has been applied and a test region to which a load has not been applied is calculated so as to determine a print condition based on the differential value ΔE and reflect the print condition to the printing apparatus 100. This makes it possible to determine a print condition that excels in the abrasion resistance. Further, in the printing apparatus according to the embodiment, the above determination of a print condition can be automatically performed with one printing apparatus and the determined print condition can be reflected to a print result as it is. Therefore, according to the invention, a print condition of the printing apparatus can be determined easily for a short period of time to perform printing in comparison with an existing method.

In the embodiment, the print condition determining processing by using the black ink has been described. However, the print condition determining unit 50 can determine a print condition for other colors of inks by using an individually printed test pattern. Further, for combined ink colors, a print condition may also be determined in the same manner in accordance with the above flow. In addition, in the embodiment, the print condition determining unit 50 compares a differential value of the brightness value between a portion of each test region to which a load has been applied and a portion of each test region to which a load has not been applied with the threshold value at the time of the determination of the print condition. However, instead of the above method, a method in which a differential value for each of R, G, and B is calculated and the differential value is compared with the threshold value for each of R, G, and B may be employed.

Further, the print condition determining unit 50 can previously acquire a value of an original color of the print medium P, which has been read by the reading controller 40. With this, when a color of the entire range of one test region becomes equal to the original color of the print medium P, the print condition determining unit 50 judges that ink is completely peeled off and eliminated in the test region. Then, the print condition determining unit 50 can exclude a print condition corresponding to the test region from conditions as selection targets without calculating a differential value ΔE thereof.

### C. Variations

As described above, one embodiment of the invention has been described. However, the invention is not limited to the embodiment and various configurations can be employed in a range without departing from the scope of the invention. For example, functions realized by software may be realized by hardware. In addition, the following variations can be made.

### C1. First Variation (Print Condition Determining Processing)

In the above embodiment, when there are a plurality of print conditions where the differential value ΔE is equal to or lower than the predetermined threshold value, the print condition determining unit 50 selects a print condition by using elements of the ink duty limit, the energy irradiation amount, the energy irradiation direction, and the lower limit value of an ink usage amount. However, the order and combination of these elements used are not limited to the method in the above embodiment. FIGS. 7 to 9 are descriptive views illustrating variations of the print condition determining processing. For example, as illustrated in FIG. 7, the print condition determining unit 50 may determine a print condition based on the ink duty limit level only while the energy irradiation amount is set to be constant at the time of the printing. On a test pattern 301 as illustrated in FIG. 7, a print condition corresponding to a test region 311 is selected based on the ink duty limit level only.

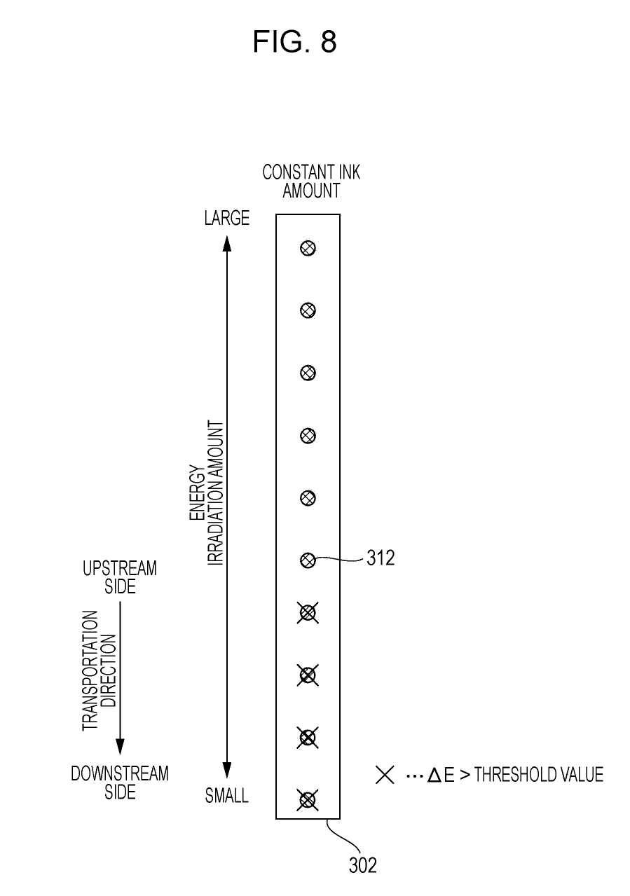

Further, as illustrated in FIG. 8, the print condition determining unit 50 may determine a print condition based on the energy irradiation amount only while the ink amount is set to be constant. On a test pattern 302 as illustrated in FIG. 8, a print condition corresponding to a test region 312 where the energy irradiation amount is smaller is selected.

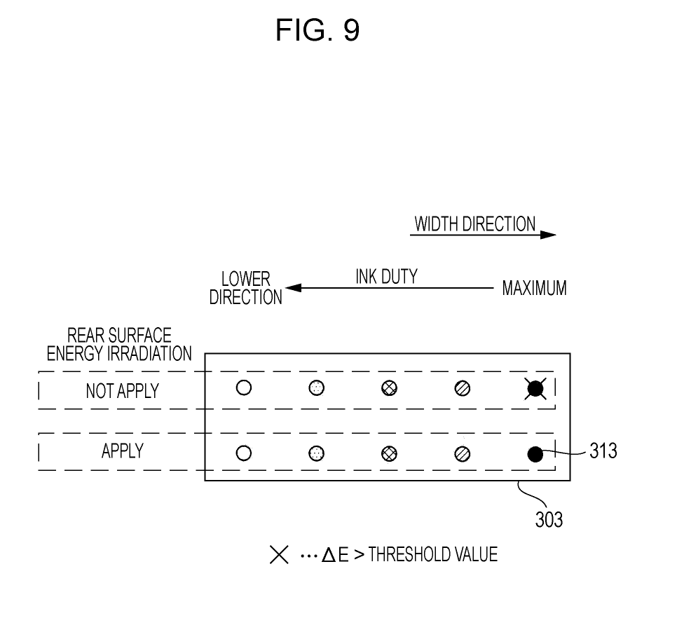

Moreover, as illustrated in FIG. 9, the print condition determining unit 50 may determine a print condition without taking the rear surface energy irradiation amount into consideration. To be more specific, ink duty limits when the rear surface energy irradiation is performed and when the rear surface energy irradiation is not performed are evaluated so as to select a condition where the ink duty limit is larger. In this case, on a test pattern 303 as illustrated in FIG. 9, a print condition corresponding to a test region 313 on which the rear surface energy irradiation is performed is selected.

Further, for example, when a print condition is determined for clear (CL) ink to be printed on other ink surfaces or an original color portion of the print medium, the print condition may be determined such that an amount of ink to be used becomes smaller. Thus, the print condition can be determined by using various methods.

In the above embodiment, the print condition determining unit 50 compares the differential value ΔE with the predetermined threshold value to narrow the print conditions. However, the print condition where the differential value ΔE is minimum may be determined as a final print condition simply. In this case, when there are a plurality of print conditions where the differential value ΔE is minimum, the print condition determining unit 50 can narrow the print conditions of the ink duty limit level and the energy irradiation amount in this order to determine a print condition in the same manner as the above embodiment.

### C2. Second Variation (Configuration of Printing Apparatus)

In the above embodiment, a white print paper has been used as the print medium P. However, the print medium to which the invention can be applied is not limited thereto. The print medium P can be replaced by print papers of various original colors or a transparent film. Further, the print condition determining processing can be performed by combining these print media and inks. For example, when clear (CL) ink is used, a black print paper can be used as the print medium. With this, the differential value ΔE with respect to a portion of which color has been changed to white due to friction with the test needles 32 can be detected. Thus, even when the print media and inks are variously changed, the printing apparatus according to the invention can determine a print condition easily for a short period of time for each print medium.

In the above embodiment, a state where nozzles are arranged in row in the line direction and test regions in row are printed has been described for the convenience of explanation. However, a zigzag test pattern can be printed with nozzles included by the printing head 11. In addition, the test pattern on which the ink amount is changed at five stages has been described for the convenience of explanation. However, the ink amount may be changed at much more stages.

In the above embodiment, the front surface irradiator 21 and the rear surface irradiator 22 irradiate the print medium P with ultraviolet rays. However, energy to be applied is not limited to the ultraviolet rays. It is sufficient that the energy to be applied is energy which makes it possible to cure ink to be used in the printing, and ultraviolet rays, infrared rays, visible rays, electronic rays, and the like can be used. Further, as illustrated in FIG. 1, the rear surface irradiator 22 is opposed to the front surface irradiator 21 with the print medium P provided therebetween. However, the rear surface irradiator 22 is not necessarily required to be opposed to the front surface irradiator 21. It is sufficient that the rear surface irradiator 22 is located at the downstream side with respect to the printing head 11 in the transportation direction of the print medium P and at the upstream side with respect to the loading unit 31 in the transportation direction.

In the above embodiment, as a unit which applies a load to test regions, the test needles 32 are used. However, the plurality of test needle 32 are not necessarily required to be provided on the loading unit 31. For example, the control unit 80 adjusts a feeding speed of the print medium P and one test needle is made to scan in the width direction so that a load can be applied to a plurality of test regions. Further, instead of the test needles 32, a unit which can apply a load to the print medium P entirely in the width direction (for example, loading roller which can pinch the print medium P with predetermined load), or a unit which presses an adhesive sticky material to the print medium P so as to peel it (device which presses an adhesive tape) can be provided. With this, a state where various loads are applied to the printed material can be reproduced so as to evaluate abrasion resistance.

Further, the control unit 80 may include a cleaning controller which controls a cleaning unit for performing maintenance on the test needles 32 and an air controller for removing impurities. The cleaning unit cleans tip ends of the test needles 32 with a solution containing an organic solvent such as ethanol, for example. The air controller removes extra impurities on the tip ends of the test needles 32 and a test pattern by blowing air, for example. With this, the printing processing of the printing apparatus 100 is not required to be stopped in order to perform maintenance on the test needles 32. Further, a configuration can be employed. That is, when the differential value ΔE becomes larger, it is judged that the cleaning controller or the air controller is required to perform maintenance so that cleaning of the test needles 32 or air blowing for removing impurities is automatically performed.

What is claimed is:

1. A printing apparatus including a printing head for discharging ink, comprising:
a printing unit which prints a plurality of test regions to be printed under a plurality of different print conditions on a print medium by the printing head;
a loading unit which applies a physical load to each of the test regions;
a reading unit which reads an image on each of the test regions to which the load has been applied; and
a determining unit which determines a print condition suitable for printing by the printing head among the plurality of different print conditions based on the read image on each of the test regions.

2. The printing apparatus according to claim 1,
wherein the printing unit prints a plurality of test regions of which amounts of ink to be discharged from the printing head per unit area are made different from one another, and
the determining unit determines a print condition relating to an amount of ink to be discharged from the printing head per unit area based on the read image on each of the test regions.

3. The printing apparatus according to claim 1,
wherein the printing unit includes a first irradiator which applies energy for curing ink discharged onto the print medium, and prints a plurality of test regions of which energies to be applied by the first irradiator are made different from one another, and
the determining unit determines a print condition relating to energy to be applied by the first irradiator based on the read image on each of the test regions.

4. The printing apparatus according to claim 3,
wherein the printing unit further includes a second irradiator which applies energy for curing ink discharged onto the print medium from a direction different from the first irradiator, and prints a plurality of test regions of which amounts or presence/absence of energy to be applied by the second irradiator are made different from one another, and
the determining unit determines a print condition relating to energy to be applied by the second irradiator based on the read image on each of the test regions.

5. A print condition determining method of a printing apparatus including a printing head for discharging ink, the method comprising:
printing a plurality of test regions to be printed under a plurality of different print conditions on a print medium by the printing head;
applying a physical load to each of the test regions;
reading an image on each of the test regions to which the load has been applied; and
determining a print condition suitable for printing by the printing head among the plurality of different print conditions based on the read image on each of the test regions.

6. A medium in which a computer program for determining a print condition of a printing apparatus including a printing head for discharging ink is recorded and which is capable of being read by a computer,
wherein
the computer program causes the computer to realize:
a printing function of printing a plurality of test regions to be printed under a plurality of different print conditions on a print medium by the printing head;
a loading function of applying a physical load to each of the test regions;
a reading function of reading an image on each of the test regions to which the load has been applied; and
a determining function of determining a print condition suitable for printing by the printing head among the plurality of different print conditions based on the read image on each of the test regions.
